(19) United States
(12) Patent Application Publication
(10) Pub. No.: US 2026/0249870 A1
(43) Pub. Date: Aug. 27, 2026

(54) WARNING DEVICE, WARNING METHOD AND NON-TRANSITORY RECORDING MEDIUM

(71) Applicants: TOYOTA JIDOSHA KABUSHIKI KAISHA, Aichi-ken (JP); DENSO CORPORATION, Aichi-pref (JP)

(72) Inventor: Hiroki SHIMAZU, Nisshin-shi (JP)

(21) Appl. No.: 19/542,669

(22) Filed: Feb. 18, 2026

(30) Foreign Application Priority Data
Feb. 26, 2025 (JP) 2025-029109

(51) Int. Cl. B60W 50/14

(52) U.S. Cl. CPC B60W 50/14; B60W 2050/143; B60W 2050/146; B60W 2420/408; B60W 2554/4041

(57) ABSTRACT

The warning device includes a processor configured to detect a moving object around a vehicle, and notify an occupant of the vehicle of a first warning in response to detection of the moving object in a first area set on a rear-lateral side of the vehicle, and a second warning in response to detection of the moving object in a second area set in front of the first area. The processor is configured to suppress the second warning when the moving object enters the second area from the first area.

### FIELD

The present disclosure relates to a warning device, a warning method, and a non-transitory recording medium.

### BACKGROUND

Conventionally, a warning device (for example, a blind spot monitor (BSM)) that alerts a driver when the surrounding vehicle located in a blind spot area of a driver of a vehicle is detected is known (for example, PTL 1).

### CITATIONS LIST

### Patent Literature

[PTL 1] Japanese Unexamined Patent Publication No. 2021-026241

### SUMMARY

### Technical Problem

However, when a moving object such as the surrounding vehicle is detected, an area in which an alert can be notified may be limited by laws and regulations, etc. For example, it is said that it is not desirable to continue to alert the moving object even after the moving object approaching the host vehicle from the rear reaches the front end of the host vehicle.

In view of the above problems, an object of the present disclosure is to suppress a warning to an occupant of a vehicle in response to detection of a moving object in an area where a warning notification is not desirable.

### Solution to Problem

The summary of the present disclosure is as follows.
(1) A warning device comprising a processor configured to: detect a moving object around a vehicle; and notify an occupant of the vehicle of a first warning in response to detection of the moving object in a first area set on a rear-lateral side of the vehicle, and a second warning in response to detection of the moving object in a second area set in front of the first area, wherein the processor is configured to suppress the second warning when the moving object enters the second area from the first area.
(2) The warning device described in above (1), wherein the warning notification unit is configured to stop the second warning for a predetermined time when a moving object entering the first area from behind is detected.
(3) The warning device described in above (2), wherein the processor is configured to stop the second warning for a predetermined time when a moving object entering the first area from behind is detected.
(4) The warning device described in above (2), wherein the processor is configured to set the predetermined time based on a length of the moving object in a front-rear direction.
(5) The warning device described in any one of above (2) to (4), wherein the processor is configured to start stopping the second warning when the moving object reaches a determination line behind a rear end of the vehicle.
(6) The warning device described in any one of above (1) to (5), wherein the processor is configured to detect the moving object located in the first area using a first sensor provided in the vehicle, and detect the moving object located in the second area using a second sensor provided in front of the first sensor in the vehicle.
(7) The warning device described in above (6), wherein the processor is configured to stop the second warning when the moving object detected using the second sensor is the same as the moving object detected using the first sensor.
(8) The warning device described in above (7), wherein the processor is configured to stop the second warning when the moving object detected using the second sensor in an area behind the second area is the same as the moving object detected using the first sensor.
(9) The warning device described in any one of above (1) to (8), wherein the processor is configured not to suppress the second warning when the moving object enters the first area from the second area.
(10) The warning device described in any one of above (1) to (9), wherein a front border of the second area is set at a front end of the vehicle.
(11) The warning device described in any one of above (1) to (10), wherein the processor is configured to continue the first warning until the moving object detected in the first area reaches an eyellipse reference line in the second area.
(12) The warning device described in above (11), wherein the processor is configured to determine whether or not the moving object has reached the eyellipse reference line based on a relative velocity of the moving object with respect to the vehicle.
(13) A warning method executed by a computer, including: detecting a moving object around a vehicle; notifying an occupant of the vehicle of a first warning in response to detection of the moving object in a first area set on a rear-lateral side of the vehicle; and a second warning in response to detection of the moving object in a second area set in front of the first area; and suppressing the second warning when the moving object enters the second area from the first area.
(14) A non-transitory recording medium having recorded thereon a computer program, the computer program causing a computer to: detect a moving object around a vehicle; notify an occupant of the vehicle of a first warning in response to detection of the moving object in a first area set on a rear-lateral side of the vehicle; and a second warning in response to detection of the moving object in a second area set in front of the first area; and suppress the second warning when the moving object enters the second area from the first area.

According to the present disclosure, it is possible to suppress a warning to an occupant of a vehicle in response to detection of a moving object in an area where a warning notification is not desirable.

### BRIEF DESCRIPTION OF DRAWINGS

FIG. 1 is a schematic configuration diagram of a warning system including a warning device according to an embodiment of the present disclosure.

FIG. 2 is a plan view of the vehicle showing an upper portion of the vehicle.

FIG. 3 is a function block diagram of a processor of an ECU.

FIG. 4 is a diagram illustrating examples of the first area and the second area set as the warning target region.

FIG. 5 is a diagram illustrating an example in which an erroneous detection of the position of the moving object occurs.

FIG. 6 is a diagram illustrating a scene in which the moving object overtakes the vehicle.

FIG. 7 is a flow chart showing a control routine of the warning stop process in the first embodiment.

FIG. 8 is a flow chart showing a control routine of the warning notification process in the first embodiment.

FIG. 9 is a diagram illustrating a scene in which the moving object overtakes the vehicle.

FIG. 10 is a flow chart showing a control routine of the warning stopping process in the second embodiment.

FIG. 11 is a diagram illustrating a scene in which the moving object overtakes the vehicle.

FIG. 12 is a flow chart showing a control routine of the warning stop process in the third embodiment.

FIG. 13 is a flow chart showing a control routine of the warning notification process in the third embodiment.

### DESCRIPTION OF EMBODIMENTS

Hereinafter, embodiments of the present disclosure will be described in detail with reference to the drawings. In the following description, the same reference numerals are given to the same constituent elements.

### First Embodiment

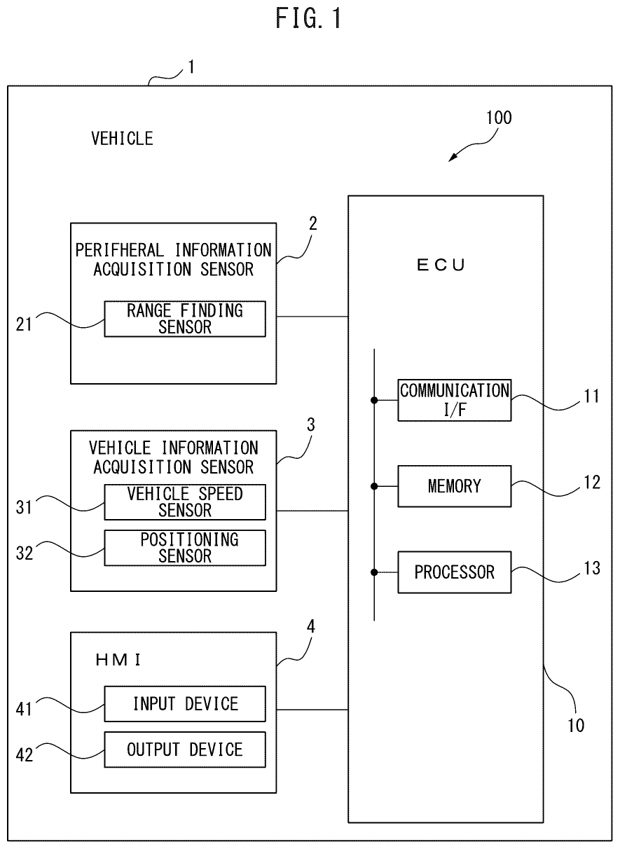

Hereinafter, a first embodiment of the present disclosure will be described with reference to FIG. 1 to FIG. 8. FIG. 1 is a schematic configuration diagram of a warning system 100 including a warning device according to an embodiment of the present disclosure. The warning system 100 is mounted on the vehicle 1 (host vehicle) and notifies an occupant (for example, a driver) of the vehicle 1 of a warning as needed. In the present embodiment, the vehicle 1 is a four-wheeled car.

As shown in FIG. 1, the warning system 100 includes a peripheral information acquisition sensor 2, a vehicle information acquisition sensor 3, a human-machine interface (HMI) 4 and an electronic control unit (ECU) 10. The peripheral information acquisition sensor 2, the vehicle information acquisition sensor 3, and the HMI 4 are electrically connected to the ECU 10 via an in-vehicle network or the like compliant with a standard such as CAN (Controller Area Network) or Ethernet.

The peripheral information acquisition sensor 2 acquires information about the surroundings of the vehicle 1. The peripheral information acquisition sensor 2 generates surrounding data of the vehicles 1 at predetermined intervals, and transmits the surrounding data to the ECU 10. The peripheral information acquisition sensor 2 includes, for example, a range finding sensor 21.

The range finding sensor 21 detects the presence of an object around the vehicle 1 and measures a distance from the vehicle 1 to the object by irradiating an electromagnetic wave (millimeter wave or laser light) or an ultrasonic wave around the vehicle 1. The range finding sensor 21 can also measure the speed and azimuth of an object around the vehicle 1. That is, the range finding sensor 21 generates point cloud data, distance data, speed data, azimuth data, and the like of an object around the vehicle 1 as surrounding data of the vehicle 1. The range finding sensor 21 includes, for example, at least one of a millimeter-wave radar, a LiDAR (Laser Imaging Detection And Ranging) and a sonar (ultrasonic sensor).

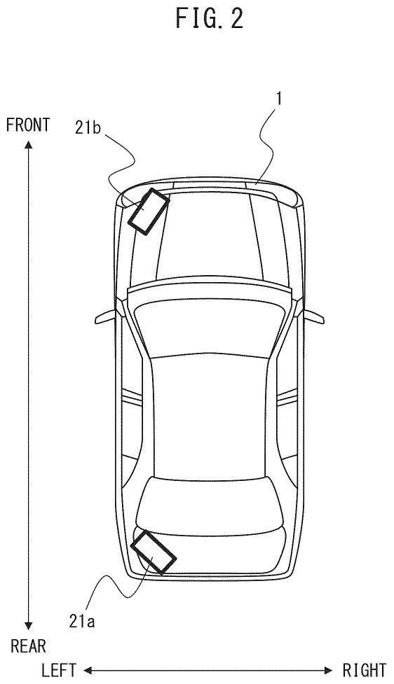

FIG. 2 is a plan view of the vehicle 1 showing an upper portion of the vehicle 1. In the present embodiment, the warning system 100 includes a rear-lateral radar 21a and a front-lateral radar 21b as the range finding sensor 21. The rear-lateral radar 21a is provided in the vehicle 1 (specifically, the rear-lateral portion of the vehicle 1), and the front-lateral radar 21b is provided in front of the rear-lateral radar 21a in the vehicle 1 (specifically, the front-lateral portion of the vehicle 1). The rear-lateral radar 21a is an example of a first sensor, and the front-lateral radar 21b is an example of a second sensor.

The rear-lateral radar 21a irradiates the rear-lateral side of the vehicle 1 with millimeter waves, and generates point cloud data and the like of an object on the rear-lateral side of the vehicle 1. In the present embodiment, as shown in FIG. 2, the rear-lateral radar 21a is provided on the left side rear-lateral portion of the vehicle 1. For example, the rear-lateral radar 21a is provided at the left corner portion of the rear bumper of the vehicle 1, and irradiates the left rear-lateral side of the vehicle 1 with millimeter waves. The output of the rear-lateral radar 21a is transmitted to the ECU 10.

The front-lateral radar 21b irradiates the front-lateral side of the vehicle 1 with millimeter waves, and generates point cloud data and the like of an object on the front-lateral side of the vehicle 1. In the present embodiment, as shown in FIG. 2, the front-lateral radar 21b is provided on the left side front-lateral portion of the vehicle 1. For example, the front-lateral radar 21b is provided at the left corner portion of the front bumper of the vehicle 1, and irradiates the left front-lateral side of the vehicle 1 with millimeter waves. The output of the front-lateral radar 21b is transmitted to the ECU 10.

The vehicle information acquisition sensor 3 acquires vehicle information (host vehicle information). The vehicle information acquisition sensor 3 generates vehicle data (behavior data, self position data, and the like of the vehicle 1) relating to the vehicle information at predetermined intervals, and transmits the vehicle data to the ECU 10. The vehicle information acquisition sensor 3 includes, for example, a vehicle speed sensor 31 and a positioning sensor 32.

The vehicle speed sensor 31 generates speed data of the vehicle 1 as the behavior data of the vehicle 1. For example, the vehicle speed sensor 31 generates speed data of the vehicle 1 by detecting the rotational speed of the wheels of the vehicle 1. The output of the vehicle speed sensor 31 is transmitted to the ECU 10.

The positioning sensor 32 measures a self position of the vehicle 1 and generates self position data of the vehicle 1. For example, the positioning sensor 32 is a GNSS (Global Navigation Satellite System) receiver. The GNSS receiver detects a present position of the vehicle 1 (for example, latitude and longitude of the vehicle 1) based on positioning information obtained from a plurality of (for example, three or more) positioning satellites. An example of the GNSS receiver is a GPS (Global Positioning System) receiver. The output of the positioning sensor 32 is transmitted to the ECU 10.

The HMI 4 is provided in the vehicle interior and exchanges data between the vehicle 1 and an occupant (for example, a driver) of the vehicle 1. The HMI 4 includes, for example, an input device 41 and an output device 42.

The input device 41 receives an input from an occupant of the vehicle 1. The input device 41 includes at least one of a touch panel, an operation button, an operation switch, and a microphone. The HMI 4 transmits input data input to the input device 41 by the occupant of the vehicle 1 to the ECU 10.

The output device 42 performs a notification to the occupant of the vehicle 1. The output device 42 includes at least one of a display, an indicator, a warning light, a speaker, a buzzer, and a vibration unit. The HMI 4 notifies the occupant of the vehicle 1 of information corresponding to the signal transmitted from the ECU 10 via the output device 42.

The ECU 10 executes various controls of the vehicles 1. As shown in FIG. 1, the ECU 10 includes a communication interface 11, a memory 12 and a processor 13. The communication interface 11 and the memory 12 are connected to the processor 13 via a signal line. In the present embodiment, one ECU 10 is provided, but a plurality of ECUs may be provided for various functions. In addition, the communication interface 11, the memory 12, and the processor 13 may be configured as one integrated circuit, or may be configured as separate circuits.

The communication interface 11 has an interface circuitry for connecting the ECU 10 to the in-vehicle network. The ECU 10 is connected to other in-vehicle devices via the communication interface 11. The communication interface 11 transmits signals received from the peripheral information acquisition sensor 2, the vehicle information acquisition sensor 3, and the input device 42 of the HMI 4 to the processor 13. The communication interface 11 transmits the signal output from the processor 13 to the output device 42 of the HMI 4.

The memory 12 includes, for example, a volatile semiconductor memory (e.g., DRAM (Dynamic Random Access Memory), SRAM (Static Random Access Memory), and the like), and a non-volatile semiconductor memory (e.g., ROM (Read Only Memory), EEPROM (Electrically Erasable Programmable Read Only Memory), a flash memory, and the like). The memory 12 stores temporary data, a computer program (a control program of the ECU 10) used for various processes by the processor 13, setting data of the ECU 10 log data, vehicle information, and the like.

The processor 13 has one or more CPU (Central Processing Unit) and its peripheral circuitry. The processor 13 executes a computer program stored in the memory 12. The processor 13 may further include other arithmetic circuits such as a logical arithmetic unit, a numerical arithmetic unit, or a graphic processing unit.

In the present embodiment, the ECU 10 functions as a warning device for notifying an occupant of the vehicle 1 of a warning. In particular, in the present embodiment, the ECU 10 notifies the occupant of the vehicle of a warning for the moving object located on the side of the vehicle 1. The ECU 10 is an example of the warning device.

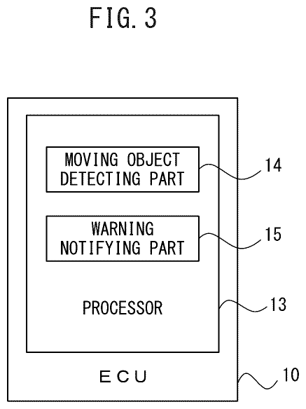

FIG. 3 is a function block diagram of the processor 13 of the ECU 10. As shown in FIG. 3, the processor 13 has a moving object detecting part 14 and a warning notifying part 15. The moving object detecting part 14 and the warning notifying part 15 are functional modules realized by the processor 13 of the ECU 10 executing a computer program stored in the memory 12 of the ECU 10. Note that these functional modules may be realized by dedicated arithmetic circuits provided in the processor 13.

The moving object detecting part 14 detects the moving object around the vehicle 1. In particular, in the present embodiment, the moving object detecting part 14 detects the moving object moving on the side of the vehicle 1. In the present specification, a moving object is an object that may pass through the side of the vehicle 1, and includes, for example, at least one of a car, a motorcycle, a bicycle, and a pedestrian.

For example, the moving object detecting part 14 detects the moving object around the vehicle 1 based on the output of the peripheral information acquisition sensor 2. The moving object detecting part 14 obtains the identification information (e.g., categories, names, etc.), position information (e.g., latitude and longitude), speed information (e.g., relative speed with respect to the vehicle 1), etc., of the moving object. based on the output of the peripheral information acquisition sensor 2. Note that the moving object detecting part 14 may acquire the information by inputting the output of the peripheral information acquisition sensor 2 into a learned machine learning model (for example, a CNN (Convolutional Neural Network), a RNN (Recurrent Neural Network), a Transformer, or the like).

The warning notifying part 15 notifies an occupant (for example, a driver) of the vehicle 1 of a warning for the moving object detected by the moving object detecting part 14. In the present embodiment, the warning notifying part 15 notifies the occupant of the vehicle 1 of a warning for the moving object located on the side of the vehicle 1. Specifically, the first area and the second area are set in advance as the warning target region, and the warning notifying part 15 notifies the occupant of the vehicle 1 of a warning when the moving object is detected in the warning target region.

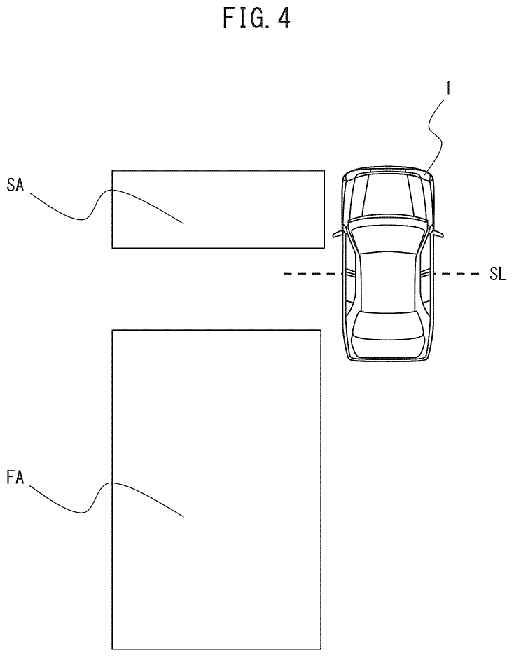

FIG. 4 is a diagram illustrating examples of the first area FA and the second area SA set as the warning target region. The first area FA and the second area SA are lateral regions of the vehicle 1 that are difficult to be directly viewed by the driver of the vehicle 1. The first area FA is set to the rear-lateral side of the vehicle 1, and the second area SA is set in front of the first area FA (the front-lateral side of the vehicle 1). In the present embodiment, the first area FA and the second area SA are areas on the left-lateral side of the vehicle 1. That is, the first area FA is set to the left rear-lateral side of the vehicle 1, and the second area SA is set to the left front-lateral side of the vehicle 1.

In the present embodiment, the moving object detecting part 14 uses the rear-lateral radar 21a to detect a moving object located on the first area FA, and uses the front-lateral radar 21b to detect a moving object located on the second area SA. In other words, the first area FA is a region in which a moving object is detected by the rear-lateral radar 21a, and the second area SA is a region in which a moving object is detected by the front-lateral radar 21b. Note that the first area FA is a region narrower than the detectable range of the rear-lateral radar 21a, and the second area SA is a region narrower than the detectable range of the front-lateral radar 21b.

The front boundary of the first area FA is set between the dividing line SL that bisects the vehicle 1 in the front-rear direction of the vehicle 1 and the rear end of the vehicle 1. The rear boundary of the first area FA is set rearward of the rear end of the vehicle 1. The front boundary of the second area SA is set at the front end of the vehicle 1. The rear boundary of the second area SA is set ahead of the front boundary of the first area FA, and in the present embodiment, is set between the dividing line SL and the front end of the vehicle 1. By setting the first area FA and the second area SA in this way, it is possible to effectively call attention to the moving object existing in the blind spot of the vehicle 1.

Note that the position of the rear boundary of the second area SA may be between the front boundary of the first area FA and the dividing line SL. Further, in the example of FIG. 4, a space exists between the first area FA and the second area SA, but the first area FA and the second area SA may be consecutive regions in the front-rear direction of the vehicle 1. Further, the position of the rear boundary of the first area FA may be changed in accordance with the relative velocity of the moving object with respect to the vehicle 1. For example, the higher the relative velocity of the moving object approaching the vehicle 1, the longer the length from the rear boundary of the first area FA to the rear end of the vehicle 1.

The warning notifying part 15 notifies the occupant of the vehicle 1 of a first warning in response to detection of a moving object in the first area FA, and a second warning in response to detection of a moving object in the second area SA. This makes it possible to direct the attention of the occupant (in particular, the driver) of the vehicle 1 to the moving object located at the blind spot of the vehicle 1, and thus to assist the driving of the vehicle 1 (for example, lane change of the vehicle 1).

Incidentally, in a scene in which a moving object approaching the vehicle 1 from the rear side of the vehicle 1 overtakes the vehicle 1, after the moving object reaches the front end of the vehicle 1, since the moving object moves away to the front side of the vehicle 1, it is unlikely that the moving object will interfere with the lane change of the vehicle 1. Therefore, in order to avoid unnecessary warning to the occupant of the vehicle 1, it is desirable to suppress the warning for the moving object after the moving object reaches the front end of the vehicle 1. Indeed, Chinese standards (Standard Number: GB/T39265-2020, Title: Road vehicles Performance requirements and testing methods for blind spot detection (BSD) system) prohibit warning for such the moving object.

However, an error may occur in the detected position of the moving object in the front-rear direction of the vehicle 1. In particular, when the moving object is located just beside the in-vehicle radar such as the rear-lateral radar 21a and the front-lateral radar 21b, the reflected wave from the right side becomes dominant, and the detecting accuracy deteriorates.

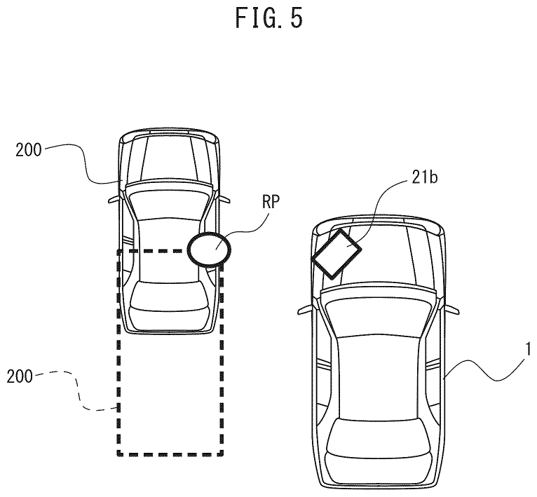

FIG. 5 is a diagram illustrating an example in which an erroneous detection of the position of the moving object occurs. In FIG. 5, the surrounding vehicle 200 is shown as the moving object. In FIG. 5, the actual position of the surrounding vehicle 200 is indicated by a solid line, and the detected position of the surrounding vehicle 200 is indicated by a broken line. In this case, since reflection from the reflected point RP right next to the front-lateral radar 21b is strong, it is determined that the surrounding vehicle 200 has not reached the front end of the vehicle 1, even though a part of the surrounding vehicle 200 is located in front of the front end of the vehicle 1. In such a situation, when the second warning is notified to the occupant of the vehicle 1 in response to the detection of the surrounding vehicle 200 by the front-lateral radar 21b, a warning is given to the detection of the moving object in an area where the warning notification is not desired, and there is a possibility that the warning may violate the legal regulations such as the above-described Chinese standards.

Therefore, in the present embodiment, the warning notifying part 15 suppresses the second warning when the moving object overtakes the vehicle 1, i.e., when the moving object enters the second area SA from the first area FA. As a result, it is possible to suppress notification of a warning for the moving object even after the moving object reaches the front end of the vehicle 1 by erroneous detection of the position of the moving object. Therefore, it is possible to suppress the warning to the occupant of the vehicle 1 in response to the detection of the moving object in the area where the warning notification is not desirable.

For example, the warning notifying part 15 stops the second warning for a predetermined time when the moving object entering the first area FA from behind is detected. As a result, when the moving object overtakes the vehicle 1, the warning in response to the detection of the moving object by the front-lateral radar 21b in the second area SA is stopped, and therefore warning for the moving object after reaching the front end of the vehicle 1 can be avoided.

It is unlikely that the moving object is determined to be located in the second area SA by erroneous detection, since there is no moving object right beside the front-lateral radar 21b when the moving object is completely out of the second area SA. Therefore, the predetermined time of stopping the second warning (hereinafter referred to as “warning stopping time”) is set to an estimated required time until the moving object that has entered the first area FA completely exits the second area SA, i.e., an estimated required time until the rear end of the moving object detected in the first area FA reaches the front boundary of the second area SA.

In this case, the warning notifying part 15 sets the warning stopping time based on, for example, the relative velocity of the moving object with respect to the vehicle 1. As a result, it is possible to improve the estimation accuracy of the estimated required time, and thus, it is possible to set the warning stopping time to an appropriate value. The estimated required time is shorter as the relative velocity of the moving object is faster. Therefore, the warning notifying part 15 shortens the warning stopping time as the relative velocity of the moving object is faster.

Further, in the present embodiment, the warning notifying part 15 sets the warning stopping time based on the length of the moving object in the front-rear direction. By considering the length of the moving object in the front-rear direction, it is possible to further improve the estimation accuracy of the estimated required time. The longer the length of the moving object in the front-rear direction, the longer it takes for the rear end of the moving object to reach the front boundary of the second area SA after the front end of the moving object reaches the front boundary of the second area SA. That is, the estimated required time is longer as the length of the moving object in the front-rear direction is longer. Therefore, the warning notifying part 15 increases the warning stopping time as the length of the moving object in the front-rear direction increases.

In the present embodiment, the warning notifying part 15 starts stopping the second warning when the moving object reaches the determination line behind the rear end of the vehicle 1. As a result, the second warning can be stopped before the moving object is detected in the second area SA, and unnecessary warnings due to erroneous detection of the front-lateral radar 21b can be reliably avoided.

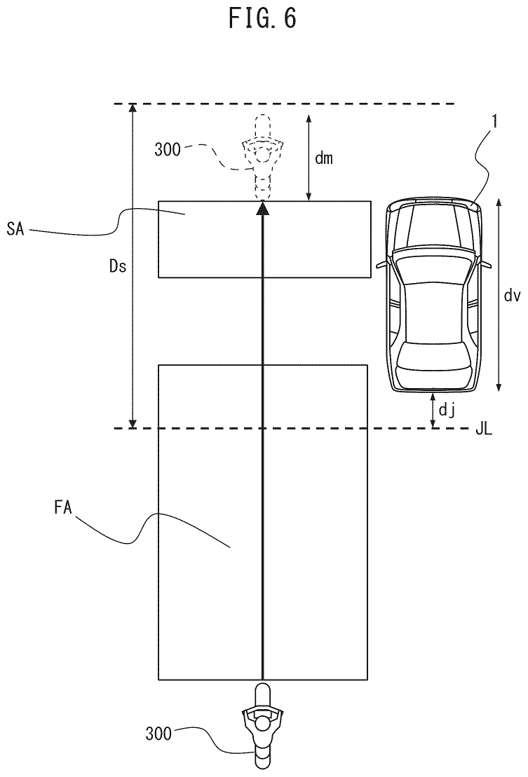

FIG. 6 is a diagram illustrating a scene in which the moving object overtakes the vehicle 1. FIG. 6 shows a motorcycle 300 as a moving object passing through the side of the vehicle 1. The determination line JL is set in the first area FA and is set between the rear end of the vehicle 1 and the rear boundary of the first area FA. The position of the determination line JL is set based on, for example, a characteristic of the rear-lateral radar 21a so that the moving object is accurately detected at the position of the determination line JL.

In the present embodiment, the warning stopping-time Ts is calculated by the following Expression (1) based on the relative velocity Vr of the moving object with respect to the vehicle 1. The relative velocity Vr is calculated based on the output of the rear-lateral radar 21a during the period until the moving object reaches the determination line JL.

Ts=Ds/Vr . . . (1)

Here, Ds is the distance until the moving object that has reached the determination line JL in the first area FA completely exits the second area SA.

The distance Ds is calculated by the following Equation (2).

Ds=dj+dv+dm+dr . . . (2)

Here, dj is the distance from the determination line JL to the rear end of the vehicle 1, dv is the length of the vehicle 1 in the front-rear direction, and dm is the length of the moving object (the motorcycle 300 in the example of FIG. 6) in the front-rear direction. dr is a radar error that is set based on the characteristics of the rear-lateral radar 21a, and is predetermined such that the second warning is not activated before the moving object completely exits the second area SA. Note that the radar error dr may be zero. In this case, the end point of the distance Ds corresponds to the front end of the moving object when the moving object completely exits the second area SA.

The length dm of the moving object in the front-rear direction is acquired based on the output of the rear-lateral radar 21a. Note that if the category of the moving object is acquired instead of the length of the moving object, the warning notifying part 15 sets the length corresponding to the category of the moving object to the length dm of the moving object in the front-rear direction. In this case, for example, the categories of the moving object include a car, a two-wheel vehicle (a bicycle or a motorcycle) and a human. The length corresponding to the category is predetermined and lengthened in the order of a human, a two-wheel vehicle, and a car. Further, if both the length and the category of the moving object are difficult to acquire, the warning notifying part 15 sets a length corresponding to a car that is longer than a two-wheel vehicle and a human to the length dm of the moving object in the front-rear direction. This makes it possible to avoid a shortage of the waring stopping time Ts regardless of the categories of the moving object.

On the other hand, when the vehicle 1 overtakes the moving object, in the situation of FIG. 5, even if a part of the moving object is actually located in front of the second area SA, the moving object then moves to a position where it is erroneously detected and prevents lane change of the vehicle 1. Therefore, even if the second warning is notified in the situation such as FIG. 5, it is unlikely that this warning will be regarded as an unnecessary warning. Indeed, there are currently no legislations that prohibit such a warning.

Therefore, in the present embodiment, the warning notifying part 15 does not suppress the second warning when the vehicle 1 overtakes the moving object, i.e., when the moving object enters the first area FA from the second area SA. As a result, when the moving object overtaken by the vehicle 1 is located in the second area SA, the attention of the occupant of the vehicle 1 can be directed to this moving object, and the driving of the vehicle 1 can be appropriately assisted.

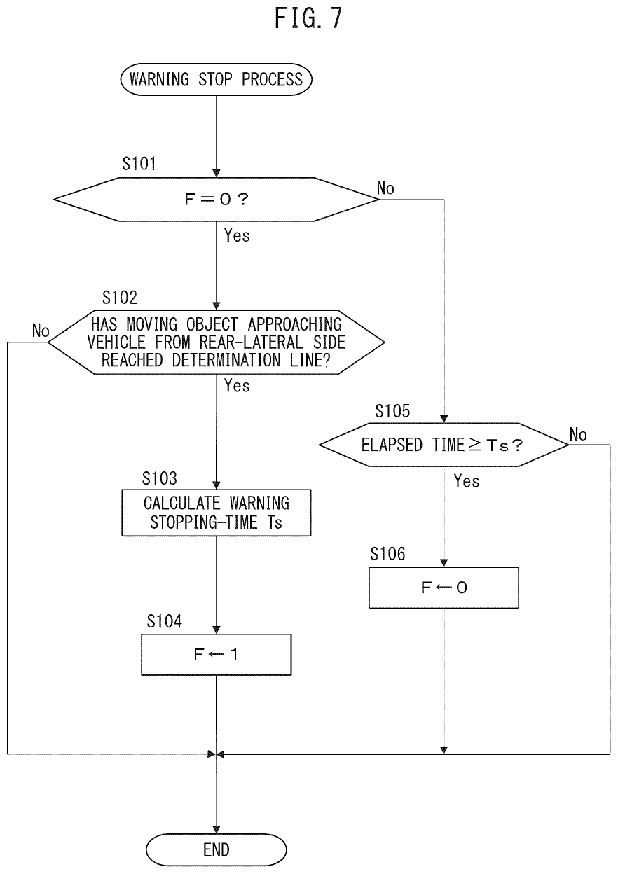

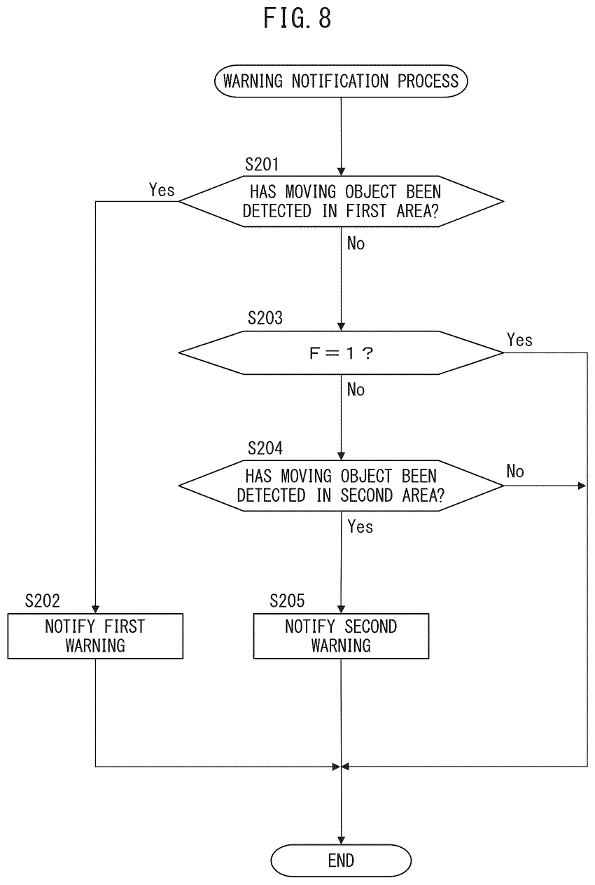

Hereinafter, the flow of the process for executing the above-described control will be described by referring to FIG. 7 and FIG. 8. FIG. 7 is a flow chart showing a control routine of the warning stop process in the first embodiment. The present control routine is repeatedly executed by the processor 13 of the ECU 10, for example, in accordance with a computer program stored in the memory 12 of the ECU 10.

First, in the step S101, the warning notifying part 15 of the processor 13 determines whether the warning stopping flag F is 0. The warning stopping flag F is a flag that is set to 1 when the second warning is stopped and is set to 0 when the second warning is not stopped (when the second warning is activated). The value of the warning stopping flag F is stored in the memory 12 of the ECU 10, and the default value of the warning stopping flag F when the power switch (for example, the ignition switch) of the vehicle 1 is turned on is set to zero.

If it is determined in the step S101 that the warning stopping flag F is zero, the present control routine proceeds to the step S102. In the step S102, the warning notifying part 15 determines whether the moving object approaching the vehicle 1 from the rear-lateral side has reached the determination line JL based on the output of the peripheral information acquisition sensor 2 (specifically, the rear-lateral radar 21a). If it is determined that the moving object has not reached the determination line JL, the present control routine ends. On the other hand, if it is determined that the moving object has reached the determination line JL, the present control routine proceeds to the step S103.

In the step S103, the warning notifying part 15 calculates the warning stopping-time Ts by the above Equation (1). Then, in the step S104, the warning notifying part 15 sets the warning stopping flag F to 1. That is, the warning notifying part 15 stops the second warning. After the step S104, the present control routine ends.

On the other hand, if it is determined in the step S101 that the warning stopping flag F is 1, the present control routine proceeds to the step S105. In the step S105, the warning notifying part 15 determines whether the elapsed time from when the warning stopping flag F is set to 1, i.e., the elapsed time from when the second warning is stopped, is equal to or more than the warning stopping time Ts. If it is determined that the elapsed time is less than the warning stopping time Ts, the present control routine ends. On the other hand, if it is determined that the elapsed time is equal to or more than the warning stopping time Ts, the present control routine proceeds to the step S106.

In the step S106, the warning notifying part 15 sets the warning stopping flag F to zero. That is, the warning notifying part 15 cancels the stopping of the second warning. After the step S106, the control routine ends.

Note that the warning stopping time Ts may be a predetermined fixed time. Further, the warning notifying part 15 may stop supplying power to the front-lateral radar 21b when the second warning is stopped. This makes it possible to avoid power being consumed in order to acquire the unnecessary output of the front-lateral radar 21b.

FIG. 8 is a flow chart showing a control routine of the warning notification process in the first embodiment. The present control routine is repeatedly executed by the processor 13 of the ECU 10, for example, in accordance with a computer program stored in the memory 12 of the ECU 10.

First, in the step S201, the warning notifying part 15 of the processor 13 determines whether a moving object has been detected in the first area FA by the moving object detecting part 14. In other words, the warning notifying part 15 determines whether a moving object located in the first area FA has been detected by the moving object detecting part 14. The moving object detecting part 14 detects the moving object in the first area FA based on the output of the peripheral information acquisition sensor 2 (specifically, the rear-lateral radar 21a).

If it is determined in the step S201 that a moving object has been detected in the first area FA, the present control routine proceeds to the step S202. In the step S202, the warning notifying part 15 notifies the occupant of the vehicle 1 of the first warning. For example, the warning notifying part 15 uses the output device 42 of the HMI 4 to notify the occupant of the vehicle 1 of at least one of a visual warning and an audible warning as the first warning. As a specific example, an indicator built in the left side mirror of the vehicle 1 is provided as the output device 42, and the warning notifying part 15 notifies the first warning by lightning this indicator. After the step S202, the present control routine ends.

On the other hand, if it is determined in the step S201 that the moving object has not been detected in the first area FA, the present control routine proceeds to step S203. In the step S203, the warning notifying part 15 determines whether the warning stopping flag F is 1. If it is determined that the warning stopping flag F is 1, the present control routine ends without determining the presence or absence of a moving object in the second area SA.

On the other hand, if it is determined in the step S203 that the warning stopping flag F is 0, the present control routine proceeds to the step S204. In the step S204, the warning notifying part 15 determines whether a moving object has been detected in the second area SA by the moving object detecting part 14. In other words, the warning notifying part 15 determines whether a moving object located in the second area SA has been detected by the moving object detecting part 14. The moving object detecting part 14 detects the moving object in the second area SA based on the output of the peripheral information acquisition sensor 2 (specifically, the front-lateral radar 21b).

If it is determined in the step S204 that the moving object has not been detected in the second area SA, the present control routine ends. On the other hand, if it is determined in step S204 that the moving object has been detected in the second area SA, the present control routine proceeds to the step S205. In the step S205, the warning notifying part 15 notifies the occupant of the vehicle 1 of the second warning. For example, the warning notifying part 15 uses the output device 42 of the HMI 4 to notify the occupant of the vehicle 1 of at least one of a visual warning and an audible warning as the second warning. As a specific example, an indicator built in the left side mirror of the vehicle 1 is provided as the output device 42, and the warning notifying part 15 notifies the second warning by lighting this indicator. After the step S205, the present control routine ends.

Note that in the present embodiment, the warning modes of the first warning and the second warning are the same, but the warning modes of the first warning and the second warning may be different. For example, a visual alert and an audible alert may be notified as the first warning and a visual alert may be notified as the second warning.

### Second Embodiment

The configuration and control of the warning device according to the second embodiment are basically the same as the configuration and control of the warning device according to the first embodiment except for the points described below. Therefore, the second embodiment of the present disclosure will be mainly described below with respect to portions different from the first embodiment.

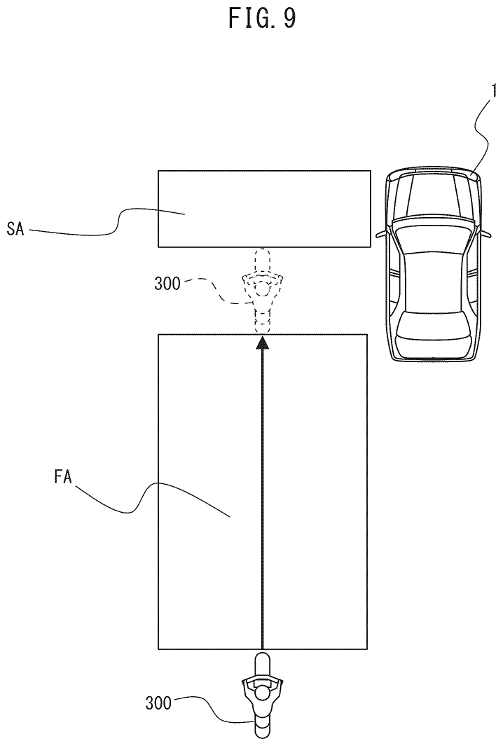

FIG. 9 is a diagram illustrating a scene in which the moving object overtakes the vehicle 1. FIG. 9 shows a motorcycle 300 as a moving object passing through the side of the vehicle 1. As described above, the warning notifying part 15 suppresses the second warning when the moving object enters the second area SA from the first area FA. Usually, if the moving object enters the second area SA from the first area FA, first, the moving object (solid motorcycle 300 in FIG. 9) is detected by the rear-lateral radar 21a, and then the same moving object (dashed motorcycle 300 in FIG. 9) is detected by the front-lateral radar 21b.

Therefore, in the second embodiment, when the moving object detected using the front-lateral radar 21b is the same as the moving object detected using the rear-lateral radar 21a, the warning notifying part 15 stops the second warning. As a result, the warning in response to the detection of the moving object by the front-lateral radar 21b is stopped when the same moving object is detected by the rear-lateral radar 21a and the front-lateral radar 21b, and therefore the warning for the moving object after reaching the front end of the vehicle 1 can be avoided.

Since the detectable range of the front-lateral radar 21b is wider than the range of the second area SA, the front-lateral radar 21b detects the moving object in the region behind the second area SA (specifically, the region between the first area FA and the second area SA), as shown in FIG. 9. That is, the warning notifying part 15 stops the second warning when the moving object detected using the front-lateral radar 21b in the region behind the second area SA is the same as the moving object detected using the rear-lateral radar 21a. This makes it possible to reliably avoid erroneous detection of the position of the moving object in the second area SA.

For example, when the first condition is satisfied, the warning notifying part 15 determines that the moving object detected using the front-lateral radar 21b is the same as the moving object detected using the rear-lateral radar 21a. The first condition is that the predetermined parameter acquired by the front-lateral radar 21b is similar to the predetermined parameter acquired by the rear-lateral radar 21a (e.g., the difference between the parameters is less than or equal to the predetermined value). The predetermined parameter includes at least one of a velocity of the recognition object (the moving object), a reflected power, a number of reflection points, a shape of the recognition object, and a traveling direction of the recognition object.

Further, when the second condition is satisfied, the warning notifying part 15 may determine that the moving object detected using the front-lateral radar 21b is the same as the moving object detected using the rear-lateral side radar 21a. The second condition is that the position of the recognition object detected by the front-lateral radar 21b is similar to the future position (e.g., the position after the predetermined time) of the recognition object estimated based on the output of the rear-lateral radar 21a (e.g., the velocity and the travelling direction of the recognition object).

Note that when the first condition and the second condition are satisfied, the warning notifying part 15 may determine that the moving object detected using the front-lateral radar 21b is the same as the moving object detected using the rear-lateral radar 21a. That is, in the second embodiment, when at least one of the first condition and the second condition is satisfied, the warning notifying part 15 determines that the moving object detected using the front-lateral radar 21b is the same as the moving object detected using the rear-lateral radar 21a.

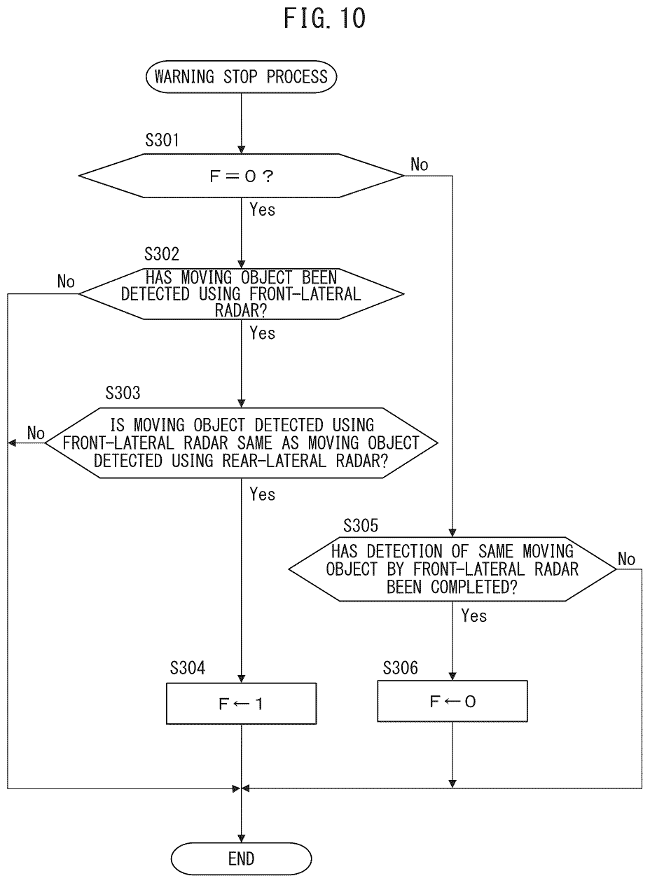

FIG. 10 is a flow chart showing a control routine of the warning stopping process in the second embodiment. The present control routine is repeatedly executed by the processor 13 of the ECU 10, for example, in accordance with a computer program stored in the memory 12 of the ECU 10.

First, in the step S301, the warning notifying part 15 of the processor 13 determines whether the warning stopping flag F is 0, similarly to the step S101 of FIG. 7. If it is determined that the warning stopping flag F is zero, the present control routine proceeds to the step S302.

In the step S302, the warning notifying part 15 determines whether a moving object has been detected by the moving object detecting part 14 using the front-lateral radar 21b. If it is determined that the moving object has not been detected, the present control routine ends. On the other hand, if it is determined that the moving object has been detected, the present control routine proceeds to the step S303.

In the step S303, the warning notifying part 15 determines whether the moving object detected using the front-lateral radar 21b is the same as the moving object detected (most recently) using the rear-lateral radar 21a. For example, when at least one of the first condition and the second condition is satisfied, the warning notifying part 15 determines that the moving object detected using the front-lateral radar 21b is the same as the moving object detected using the rear-lateral radar 21a. If it is determined that the moving objects are not the same, the present control routine ends. On the other hand, if it is determined that the moving objects are the same, the present control routine proceeds to the step S304.

In the step S304, the warning notifying part 15 sets the warning stopping flag F to 1. That is, the warning notifying part 15 stops the second warning. After the step S304, the control routine ends.

On the other hand, if it is determined in the step S301 that the warning stopping flag F is 1, the present control routine proceeds to the step S305. In the step S305, the warning notifying part 15 determines whether the detection of the same moving object by the front-lateral radar 21b has been completed. That is, the warning notifying part 15 determines whether the moving object determined to be the same has exited the detectable area of the front-lateral radar 21b. If it is determined that the detection of the same moving object has not been completed, the present control routine ends. On the other hand, if it is determined that the detection of the same moving object has been completed, the present control routine proceeds to the step S306.

In the step S306, the warning notifying part 15 sets the warning stopping flag F to zero. That is, the warning notifying part 15 cancels stopping of the second warning. After the step S306, the present control routine ends.

Note that, in the step S303, unlike the example of FIG. 9, it may be determined whether the moving object detected using the front-lateral radar 21b when at least a part of the moving object enters the second area SA is the same as the moving object detected using the rear-lateral radar 21a. Further, in the step S305, the warning notifying part 15 may determine whether the elapsed time from when the warning stopping flag F is set to 1, i.e., the elapsed time from when the second warning is stopped, is equal to or greater than the predetermined time.

In the second embodiment as well, the control routine of the warning notification process of FIG. 8 is executed, similarly to the first embodiment.

### Third Embodiment

The configuration and control of the warning device according to the third embodiment are basically the same as the configuration and control of the warning device according to the first embodiment except for the points described below. Therefore, the third embodiment of the present disclosure will be mainly described below with respect to portions different from the first embodiment.

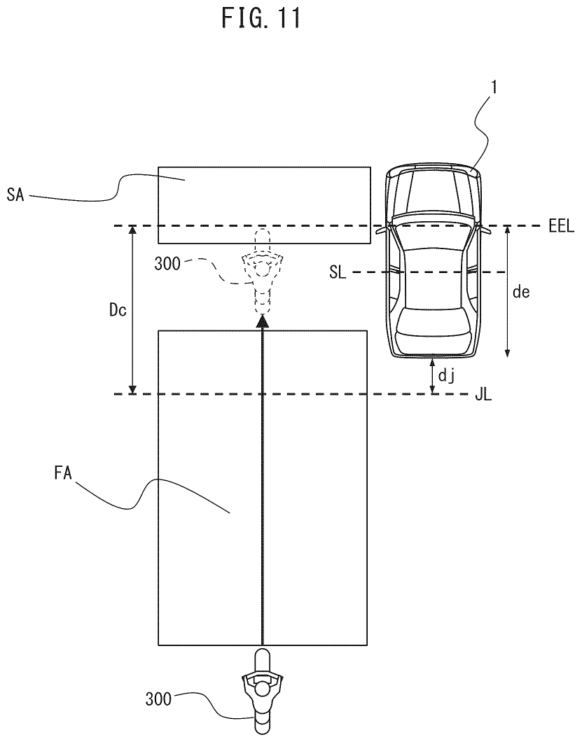

FIG. 11 is a diagram illustrating a scene in which the moving object overtakes the vehicle 1. FIG. 11 shows a motorcycle 300 as a moving object passing through the side of the vehicle 1. As described above, the warning notifying part 15 suppresses the second warning when the moving object enters the second area SA from the first area FA. However, it is desirable that warning for the moving object located at the blind spot of the vehicle 1 is continued even after the moving object exits the first area FA.

Therefore, in the third embodiment, the warning notifying part 15 continues the first warning until the moving object detected in the first area FA reaches the eyellipse reference line EEL in the second area SA. This makes it possible to direct the attention of the occupant (in particular, the driver) of the vehicle 1 to the moving object located at the blind spot of the vehicle 1 while suppressing an unnecessary warning caused by erroneous detection of the position of the moving object in the second area SA.

The eyellipse is an ellipse representing the eye ranges of the driver's right and left eyes (statistically representing the position of the driver's eyes) in side and planar views, which is defined in ISO 4513. In the present specification, the eyellipse reference line EEL is a reference line in the vehicle-width direction (left-right direction) indicated on the eyellipse. The eyellipse reference line EEL can be set for each vehicle type, for example, in accordance with the Japanese Industrial Standard (JIS D 0021: Eye range of drivers for automobiles).

In the present embodiment, as shown in FIG. 11, the eyellipse reference line EEL is set between the dividing line SL that bisects the vehicle 1 in the front-rear direction of the vehicle 1 and the front end of the vehicle 1. In addition, the eyellipse reference line EEL is set in the second area SA and is set between the front boundary of the second area SA and the rear boundary of the second area SA.

The warning notifying part 15 continues the first warning, for example, from when the moving object reaches the determination line JL behind the rear end of the vehicle 1 until the warning continuation time elapses. In the present embodiment, the warning continuation time Tc is calculated based on the relative speed of the moving object with respect to the vehicle 1, and the warning notifying part 15 determines whether the moving object has reached the eyellipse reference line EEL based on the relative speed of the moving object. As a result, the warning continuation time Tc can be set to an appropriate value, and it is possible to suppress the first warning from being continued even after the moving object reaches the front end of the vehicle 1.

The warning continuation time Tc is calculated by the following Equation (3). The relative velocity Vr is calculated based on the output of the rear-lateral radar 21a during the period until the moving object reaches the determination line JL.

Tc=Dc/Vr . . . (3)

Here, Dc is the distance from the determination line JL to the eyellipse reference line EEL.

The distance Dc is calculated by the following Equation (4).

Ds=dj+de . . . (4)

Here, dj is the distance from the determination line JL to the rear end of the vehicle 1, and de is the distance from the rear end of the vehicle 1 to the eyellipse reference line EEL.

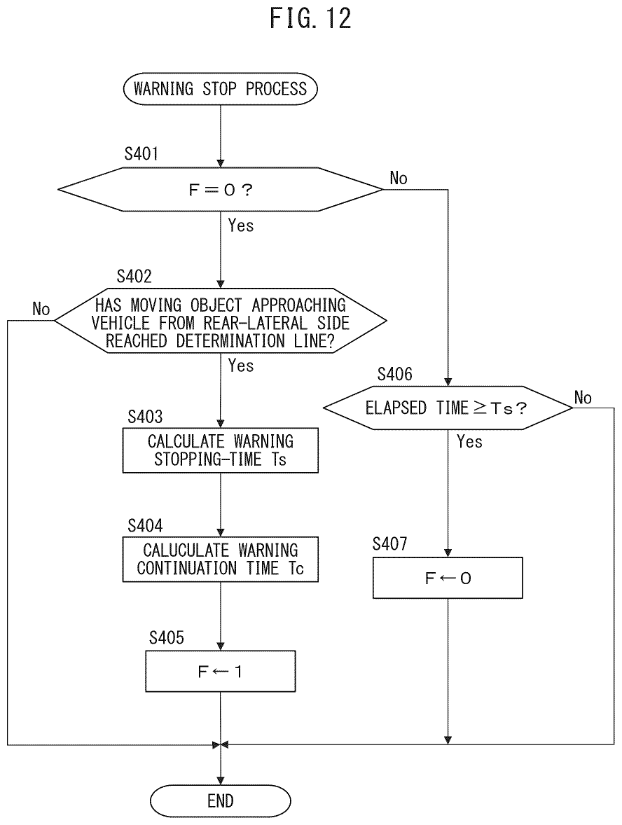

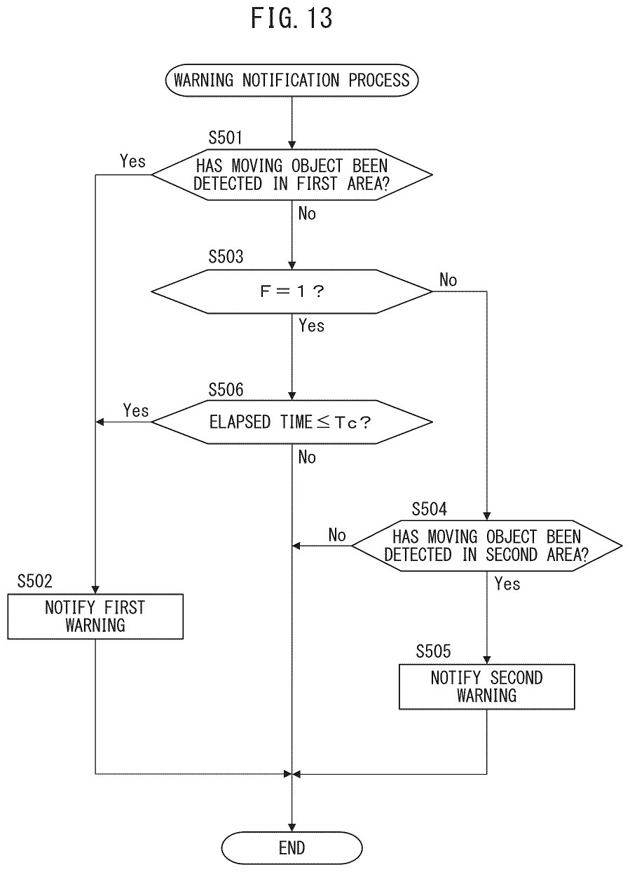

Hereinafter, a flow of a process for executing the control in the third embodiment will be described referring to FIG. 12 and FIG. 13. FIG. 12 is a flow chart showing a control routine of the warning stopping process in the third embodiment. The present control routine is repeatedly executed by the processor 13 of the ECU 10, for example, in accordance with a computer program stored in the memory 12 of the ECU 10.

First, in the step S401, the warning notifying part 15 of the processor 13 determines whether the warning stopping flag F is 0, similarly to the step S101 of FIG. 7. If it is determined that the warning stopping flag F is zero, the present control routine proceeds to the step S402.

If it is determined in the step S401 that the warning stopping flag F is zero, the present control routine proceeds to the step S402. In the step S402, similarly to the step S102 of FIG. 7, the warning notifying part 15 determines whether the moving object approaching the vehicle 1 from behind has reached the determination line JL. If it is determined that the moving object has not reached the determination line JL, the present control routine ends. On the other hand, if it is determined that the moving object has reached the determination line JL, the present control routine proceeds to the step S403.

In the step S403, the warning notifying part 15 calculates the warning continuation time Ts, similarly to the step S103 of FIG. 7. Then, in the step S404, the warning notifying part 15 calculates the warning continuation time Tc by the above Equation (3).

Next, in the step S405, the warning notifying part 15 sets the warning stopping flag F to 1. That is, the warning notifying part 15 stops the second warning. After the step S405, the control routine ends.

On the other hand, if it is determined in the step S401 that the warning stopping flag F is 1, the present control routine proceeds to the step S406. The steps S406 and S407 are executed similarly to the steps S105 and S106 of FIG. 7, and after the step S407, the present control routine ends.

FIG. 13 is a flow chart showing a control routine of the warning notification process in the third embodiment. The present control routine is repeatedly executed by the processor 13 of the ECU 10, for example, in accordance with a computer program stored in the memory 12 of the ECU 10.

The steps S501 to S505 are executed similarly to the steps S201 to S205 of FIG. 8. On the other hand, if it is determined in the step S503 that the warning stopping flag F is 1, the present control routine proceeds to the step S506.

In the step S506, the warning notifying part 15 determines whether the elapsed time from when the warning stopping flag F is set to 1, i.e., the elapsed time from when the moving object reaches the determination line JL is equal to or less than the warning continuation time Tc. If it is determined that the elapsed time is longer than the warning continuation time Tc, the present control routine ends. On the other hand, if it is determined that the elapsed time is less than or equal to the warning continuation time Tc, the present control routine proceeds to the step S502.

In the step S502, similarly to the step S202 of FIG. 8, the warning notifying part 15 notifies the occupant of the vehicle 1 of the first warning. After the step S502, the present control routine ends.

### Other Embodiments

While preferred embodiments of the present disclosure have been described above, the present disclosure is not limited to these embodiments, and various modifications and changes can be made within the scope of the claims. For example, the warning notifying part 15 may suppress the second warning when the moving object enters the first area FA from the second area SA. Further, the front boundary of the first area FA may be set at another position such as the eyellipse reference line EEL, etc.

Further, the range finding sensor 21 may be provided on the right-lateral portion of the vehicle 1 instead of the left-lateral portion of the vehicle 1 or in addition to the left-lateral portion of the vehicle 1. In this case, the first area FA and the second area SA are set as regions on the right side of the vehicle 1, and a warning for the moving object passing through the right side of the vehicle 1 is notified as in the above-described embodiment. Further, in the first embodiment or the third embodiment, instead of the rear-lateral radar 21a and the front-lateral radar 21b, one lateral radar including the first area FA and the second area SA in the detectable area may be provided on a lateral portion (at least one of a left-lateral portion and a right-lateral portion) of the vehicle 1 as the range finding sensor 21.

Further, a server or the like provided outside the vehicle 1 and capable of communicating with the vehicle 1 may function as the warning device. In this case, information for detecting an object around the vehicle 1, for example, an output of the peripheral information acquisition sensor 2, is transmitted from the vehicle 1 to the server, and the ECU 10 of the vehicle 1 notifies the occupant of the vehicle 1 of a warning via the output device 42 based on an instruction from the server. Further, the vehicle 1 may be an autonomous vehicle in which at least a part of acceleration, braking and steering of the vehicle 1 is automatically executed.

Further, the second embodiment and the third embodiment can be implemented in combination. In this case, in the second embodiment, the warning notifying part 15 continues the first warning until the moving object detected in the first area FA reaches the eyellipse reference line EEL in the second area SA.

In addition, a computer program that causes a computer to realize the functions of the respective parts included in the processor 13 of the ECU 10 or the processor of the server may be provided in a form stored in a computer-readable recording medium or a form included in a computer program product. The computer-readable recording medium is, for example, a magnetic recording medium, an optical recording medium, or a semiconductor memory.

1. A warning device comprising a processor configured to:
detect a moving object around a vehicle; and
notify an occupant of the vehicle of a first warning in response to detection of the moving object in a first area set on a rear-lateral side of the vehicle, and a second warning in response to detection of the moving object in a second area set in front of the first area, wherein
the processor is configured to suppress the second warning when the moving object enters the second area from the first area.

2. The warning device according to claim 1, wherein the processor is configured to stop the second warning for a predetermined time when a moving object entering the first area from behind is detected.

3. The warning device according to claim 2, wherein the processor is configured to set the predetermined time based on a relative velocity of the moving object with respect to the vehicle.

4. The warning device according to claim 2, wherein the processor is configured to set the predetermined time based on a length of the moving object in a front-rear direction.

5. The warning device according to claim 2, wherein the processor is configured to start stopping the second warning when the moving object reaches a determination line behind a rear end of the vehicle.

6. The warning device according to claim 1, wherein the processor is configured to detect the moving object located in the first area using a first sensor provided in the vehicle, and detect the moving object located in the second area using a second sensor provided in front of the first sensor in the vehicle.

7. The warning device according to claim 6, wherein the processor is configured to stop the second warning when the moving object detected using the second sensor is the same as the moving object detected using the first sensor.

8. The warning device according to claim 7, wherein the processor is configured to stop the second warning when the moving object detected using the second sensor in an area behind the second area is the same as the moving object detected using the first sensor.

9. The warning device according to claim 1, wherein the processor is configured not to suppress the second warning when the moving object enters the first area from the second area.

10. The warning device according to claim 1, wherein a front border of the second area is set at a front end of the vehicle.

11. The warning device according to claim 1, wherein the processor is configured to continue the first warning until the moving object detected in the first area reaches an eyellipse reference line in the second area.

12. The warning device according to claim 11, wherein the processor is configured to determine whether or not the moving object has reached the eyellipse reference line based on a relative velocity of the moving object with respect to the vehicle.

13. A warning method executed by a computer, including:
detecting a moving object around a vehicle;
notifying an occupant of the vehicle of a first warning in response to detection of the moving object in a first area set on a rear-lateral side of the vehicle; and a second warning in response to detection of the moving object in a second area set in front of the first area; and
suppressing the second warning when the moving object enters the second area from the first area.

14. A non-transitory recording medium having recorded thereon a computer program, the computer program causing a computer to:
detect a moving object around a vehicle;
notify an occupant of the vehicle of a first warning in response to detection of the moving object in a first area set on a rear-lateral side of the vehicle; and a second warning in response to detection of the moving object in a second area set in front of the first area; and
suppress the second warning when the moving object enters the second area from the first area.
